(19) United States
(12) Patent Application Publication
(10) Pub. No.: US 2024/0210760 A1
(43) Pub. Date: Jun. 27, 2024

(54) LIQUID CRYSTAL DISPLAY DEVICE AND HEAD MOUNTED DISPLAY

(71) Applicant: Japan Display Inc., Tokyo (JP)

(72) Inventor: Tetsuya OOSHIMA, Tokyo (JP)

(21) Appl. No.: 18/391,863

(22) Filed: Dec. 21, 2023

(30) Foreign Application Priority Data
Dec. 22, 2022 (JP) 2022-205916

(51) Int. Cl. G02F 1/13357; G02B 5/30; G02B 27/01

(52) U.S. Cl. CPC G02F 1/13362; G02B 5/3033; G02B 5/3083; G02B 27/0172; G02F 1/133605

(57) ABSTRACT

A liquid crystal display device includes a transmissive liquid crystal panel having a first surface and a second surface opposite the first surface, a first polarizing film arranged on a side of the first surface of the transmissive liquid crystal panel, a second polarizing film arranged on an opposite side of the first polarizing film from the transmissive liquid crystal panel, and a third polarizing film arranged on a side of the second surface of the transmissive liquid crystal panel. An absorption axis of the first polarizing film is arranged parallel to an initial alignment direction of liquid crystal molecules included in the transmissive liquid crystal panel, the first polarizing film and the third polarizing film are arranged in a crossed Nicol manner, and an absorption axis of the second polarizing film is inclined with respect to the absorption axis of the first polarizing film.

### CROSS-REFERENCE TO RELATED APPLICATIONS

This application claims the benefit of priority to Japanese Patent Application No. 2022-205916, filed on Dec. 22, 2022, the entire contents of which are incorporated herein by reference.

### FIELD

An embodiment of the present invention relates to a configuration of an optical film provided in a liquid crystal display device.

### BACKGROUND

Currently, technologies that provide virtual reality (VR) and augmented reality (AR) are being put into practical use. A head-mounted display (HMD) is a head-mounted type liquid crystal display device which is configured to display an image on a liquid crystal panel arranged in front of the eyes while the device body is mounted on the head, and is used in realizing VR and AR. Since a shielded head-mounted display blocks outside light, a liquid crystal display device with a backlight is used (refer to, for example, Japanese Unexamined Patent Application Publication No. 2019-144329).

The head mount display is arranged with lenses on the front surface (between the liquid crystal display panel and the observer) of the liquid crystal display panel so as to enable the observer to view an image having a high sense of reality. If the predetermined focal length is designed as a straight line, the head-mounted display becomes large. Therefore, an optical path in which light travels back and forth is designed using an optical film such as a reflection type polarizer or a retardation plate, and the device is miniaturized.

There are a variety of designs for head-mounted display optics, the polarization state of the light emitted from the liquid crystal display panel may be different from the polarization state of the light required on the side of the built-in equipment for which the optical system is designed.

### SUMMARY

A liquid crystal display device in an embodiment according to the present invention includes a transmissive liquid crystal panel having a first surface and a second surface opposite the first surface, a first polarizing film arranged on a side of the first surface of the liquid crystal panel, a second polarizing film arranged on an opposite side of the second polarizing film from the first polarizing film, and a third polarizing film arranged on a side of the second surface of the liquid crystal panel. An absorption axis of the first polarizing film is arranged parallel to an initial alignment direction of liquid crystal molecules included in the liquid crystal panel, the first polarizing film and the third polarizing film are arranged in a crossed Nicol manner, and an absorption axis of the second polarizing film is inclined with respect to the absorption axis of the first polarizing film.

### BRIEF DESCRIPTION OF DRAWINGS

FIG. 1 is a schematic diagram showing a configuration of a liquid crystal display device in an embodiment according to the present invention.

FIG. 2 is a schematic diagram showing a configuration of a liquid crystal display device in an embodiment according to the present invention.

FIG. 3 is a schematic diagram showing a configuration of a liquid crystal display device in an embodiment according to the present invention.

FIG. 4 shows the results of a simulation as to what degree there is a reduction in transmittance when the absorption axes of two polarizing films are shifted.

FIG. 5 is a schematic diagram showing a configuration of a head-mounted display incorporating a liquid crystal display device in an embodiment according to the present invention.

### DESCRIPTION OF EMBODIMENTS

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by A, B, a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

A configuration of a polarizing film and retardation film will be described in detail in the following embodiments. However, embodiments of the present invention are not limited to polarizing films and retardation films, and polarizing films and retardation films can be replaced with polarizing plates and retardation plates, respectively. That is, the polarizing film and polarizing plate, and the retardation film and retardation plate are synonymous.

### First Embodiment

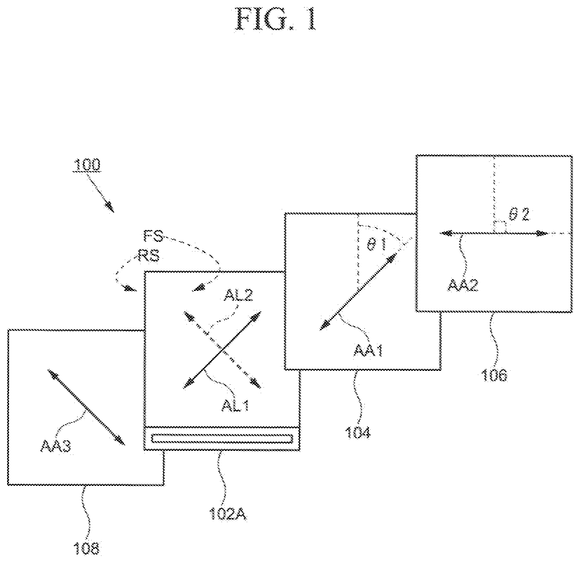

FIG. 1 shows a configuration of polarizing films that constitute a liquid crystal display device 100 according to an embodiment of the present invention. The liquid crystal display device 100 includes a liquid crystal panel 102A, a first polarizing film 104, a second polarizing film 106, and a third polarizing film 108. FIG. 1 shows a front side of the liquid crystal panel 102A as a first plane FS and an opposite side of the first plane FS as a second plane RS, for convenience of explanation. The first plane FS and the second plane RS have a front and rear relationship.

As shown in FIG. 1, the first polarizing film 104 and the second polarizing film 106 are arranged on the side of the first plane FS of the liquid crystal panel 102A, and the third polarizing film 108 is arranged on the side of the second plane RS of the liquid crystal panel 102A. Although not shown in FIG. 1, a light source (backlight) is arranged on the side of the second plane RS. The liquid crystal display device 100 has a configuration in which light emitted from a light source (backlight), which is not shown in the figure, is emitted through the third polarizing film 108, the liquid crystal panel 102A, the first polarizing film 104, and the second polarizing film 106. In other words, the liquid crystal display device 100 has a configuration in which the third polarizing film 108 is arranged on the side where light from the light source (backlight) enters, and the first polarizing film 104 and the second polarizing film 106 are arranged on the side where light emitted through the liquid crystal panel 102A is emitted.

The liquid crystal panel 102A is a TN (Twisted Nematic) type in this embodiment. Although not shown in FIG. 1 in detail, the liquid crystal panel 102A is configured including a first substrate on the first plane FS, a second substrate on the second plane RS, and a liquid crystal layer sandwiched between the first substrate and the second substrate. A first alignment film (not shown) is arranged on the first substrate side, and a second alignment film (not shown) is arranged on the second substrate side. FIG. 1 shows an alignment axis AL1 of the first alignment film as a solid line and an alignment axis AL2 of the second alignment film as a dotted line. Since the liquid crystal panel 102A is TN type, the alignment axis AL1 of the first alignment film and the alignment axis AL2 of the second alignment film are aligned orthogonally. The alignment axis in the liquid crystal panel refers to the initial alignment direction in each alignment film, which is the direction in which the long axis of liquid crystal molecules is directed when there is no electric field.

The alignment axis in this embodiment refers to the direction in which the long axis direction of the liquid crystal molecules aligns under the orientation-regulating force of the alignment film in the state where a voltage is not applied.

FIG. 1 shows an absorption axis of the first polarizing film 104, the second polarizing film 106, and the third polarizing film 108. The first polarizing film 104, the second polarizing film 106, and the third polarizing film 108 are all linear polarizing films and have a transmission axis in the direction perpendicular to the absorption axis.

The first polarizing film 104 is arranged so that an absorption axis AA1 faces the same direction (parallel) as the alignment axis AL1 of the liquid crystal panel 102A. The third polarizing film 108 is arranged so that an absorption axis AA3 faces the same direction (parallel) as the alignment axis AL2 of the liquid crystal panel 102A. Therefore, the absorption axis AA1 of the first polarizing film 104 and the absorption axis AA3 of the third polarizing film 108 are arranged in a crossed Nicol manner (orthogonal), and in this respect, it is the same as in conventional liquid crystal display devices.

In contrast, the liquid crystal display device 100 according to the present embodiment has a configuration in which the second polarizing film 106 is further arranged on the outside of the first polarizing film 104. That is, the second polarizing film 106 is arranged on the side of the liquid crystal panel 102 of the first polarizing film 104 opposite to the first plane FS side. The first polarizing film 104 and the second polarizing film 106 overlap in a plane view, but are arranged so that the directions of the absorption axes do not coincide but are different.

As described above, the absorption axis AA1 of the first polarizing film 104 is arranged parallel to the alignment axis AL1 (initial alignment direction of liquid crystal molecules) of the liquid crystal panel 102A. In contrast, the absorption axis AA2 of the second polarizing film 106 is arranged depending on the specifications of the device in which the liquid crystal display device 100 is installed.

FIG. 1 shows the absorption axis AA1 of the first polarizing film 104 inclined at an angle θ1 with respect to the vertical direction. In contrast, the absorption axis AA2 of the second polarizing film 106 is inclined at an angle θ2 (>θ1) with respect to the vertical direction. Specifically, FIG. 1 shows an example in which the absorption axis AA1 of the first polarizing film 104 is inclined at an angle θ1 of 45 degrees from the vertical direction and the absorption axis AA2 of the second polarizing film 106 is inclined at 90 degrees from the vertical direction.

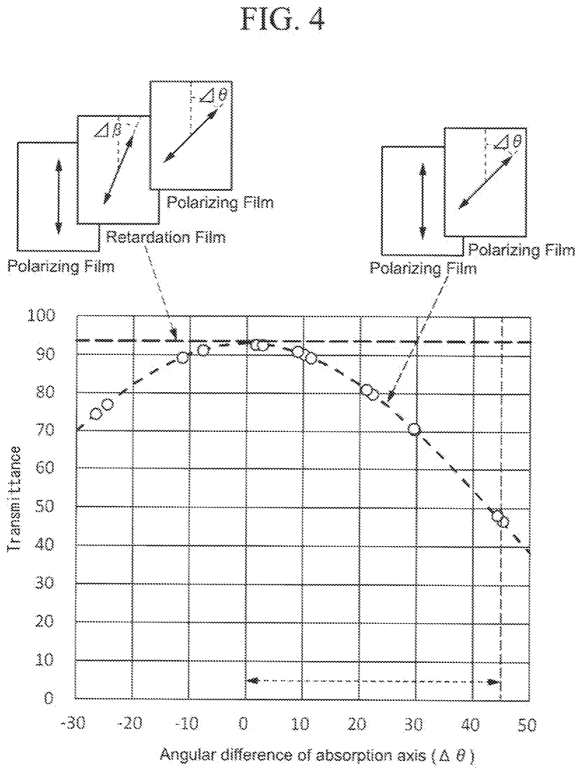

The polarizing film has the characteristic of absorbing polarized components parallel to the absorption axis and transmitting polarized components parallel to the transmission axis for the incident light. Therefore, when the absorption axes of two polarizing films are not aligned, a decrease in transmittance is expected. FIG. 4 shows the results of a simulation of the degree of decrease in transmittance when the absorption axes of the two polarizing films are misaligned. The transmittance shown on the vertical axis of the graph in FIG. 4 is a normalized value with the transmittance of one polarizing film as 100.

When there is no angular difference between the two polarizing films (Δθ=0), the transmittance is approximately 7% lower than when there is only one polarizing film, resulting in a normalized transmittance of 93%. As shown in the figure inserted in the graph, when one polarizing film is rotated and the angular difference (Δθ) between the absorption axes of the two polarizing films increases, the transmittance tends to decrease in proportion to COS² (Δθ). The normalized transmittance in the case when an angular difference of absorption axis Δθ=5 is 93%, the normalized transmittance in the case when an angular difference of absorption axis Δθ=25 is 76%, and 47% is obtained even in the case when Δθ=45. Therefore, it is possible to obtain transmitted light when the angular difference Δθ (=θ2−θ1) between the angle θ1 of the absorption axis AA1 of the first polarizing film 104 and the angle θ2 of the absorption axis AA2 of the second polarizing film 106 is greater than 0 degrees and 45 degrees or less, and when the angle difference is between 5 degrees or more and 30 degrees or less, it is possible to suppress the attenuation of the transmitted light to 30% or less, which is preferred. Furthermore, it is possible to suppress the attenuation of transmitted light to 7% or more and 25% or less when the angular difference Δθ is greater than 0 degrees and less than or equal to 25 degrees. Furthermore, it is possible to suppress the attenuation of transmitted light to 7% or more and 15% or less when the angular difference Δθ is greater than 0 degrees and less than or equal to 15 degrees. Furthermore, it is possible to suppress the attenuation of transmitted light to 7% or more and 10% or less when the angular difference Δθ is greater than 0 degrees and less than 105 degrees.

As shown in this embodiment, it is possible to adjust the direction of the absorption axis to match the specifications of the device to be installed without redesigning the liquid crystal panel 102A itself, by using two polarizing films to be configured on the light emitting side of the liquid crystal panel 102A, arranging the absorption axis of the first polarizing film 104, which is arranged on the side of the liquid crystal panel 102A, to align with the alignment axis of the liquid crystal panel 102A, and arranging the absorption axis of the second polarizing film 106, which is arranged outside the first polarizing film 104, to match the specifications of the device to be incorporated. In this case, it is possible to suppress the attenuation of light emitted from the liquid crystal panel 102A by setting the angular difference Δθ between the absorption axes of the two polarizing films to be greater than 0 degrees and 45 degrees or less.

In this embodiment, the example of liquid crystal panel 102A being TN type is shown, but there is no limitation on the type of liquid crystal panel, and the same can be applied to the case where an IPS type liquid crystal panel is used.

### Second Embodiment

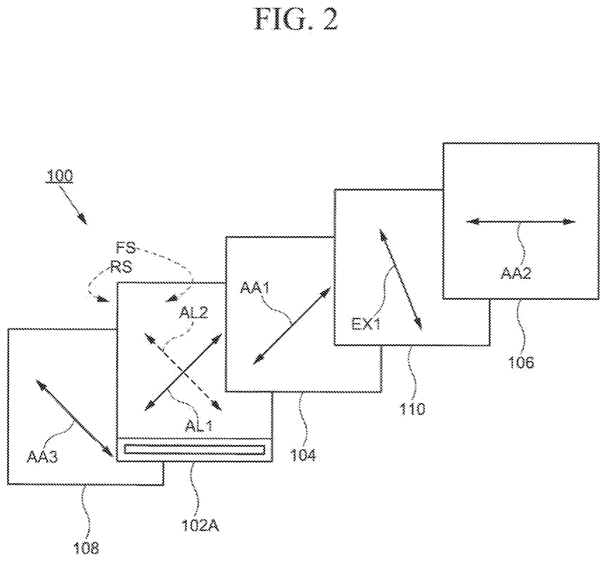

FIG. 2 shows a configuration in which a retardation film 110 is arranged between the first polarizing film 104 and the second polarizing film 106, in contrast to the liquid crystal display device 100 shown in the first embodiment. The retardation film 110 is a ½-retardation film. It is preferred that a stretching axis EX1 of the retardation film 110 is arranged to face the direction of the absorption axis AA1 of the first polarizing film 104 and the direction of the absorption axis AA2 of the second polarizing film 106, or to face a direction midway between the direction of the transmission axis (absorption axis AA1+90 degrees) of the first polarizing film 104 and the transmission axis (absorption axis AA2+90 degrees) of the second polarizing film 106. The stretching axis EX1 of the retardation film 110 is facing in the direction midway between the absorption axes of the respective polarizing films in FIG. 2. For details, a direction of the stretching axis EX1 is intermediate between a direction of a direction of the absorption axis AA1 and a direction of the absorption axis AA2 in FIG. 2. The same effect can be obtained when the stretching axis EX1 of the retardation film 110 is facing in the direction midway between the transmission axes of the respective polarizing films. In other words, a direction of +90 degrees with respect to the direction of the EX1 shown in FIG. 2 can also be adopted for the stretching axis EX1 of the retardation film 110.

When the retardation film 110 is a ½-wavelength polarizing film, it is possible to rotate the direction of polarization by 2θx and emit the light when the direction of polarization of the incident light is incident at an angle θx with respect to the stretching axis EX1. Therefore, when the angular difference between the absorption axis AA1 of the first polarizing film 104 and the absorption axis AA2 of the second polarizing film 106 is large, the polarization direction can be rotated by the retardation film 110, and even if an angular difference between the two absorption axes is produced, the transmitted light can be suppressed from decreasing.

FIG. 4 shows the normalized transmittance when a retardation film (½ wavelength) is arranged between two polarizing films with different absorption axis directions. As shown in the graph in FIG. 4, when the angular difference between the absorption axes of the two polarizing films is Δθ, the attenuation of transmittance can be prevented by setting the angular difference between the absorption axis AA1 of the first polarizing film 104 and the stretching axis of the retardation film Δβ to ½ of Δθ.

As shown in this embodiment, it is possible to prevent a decrease in transmitted light intensity by arranging a retardation film between the two polarizing films arranged on the light emitting side of the liquid crystal panel 102A. In particular, it is possible to significantly prevent a decrease in the transmitted light intensity by arranging a retardation film when the angular difference in the absorption axes of the two polarizing films is large.

### Third Embodiment

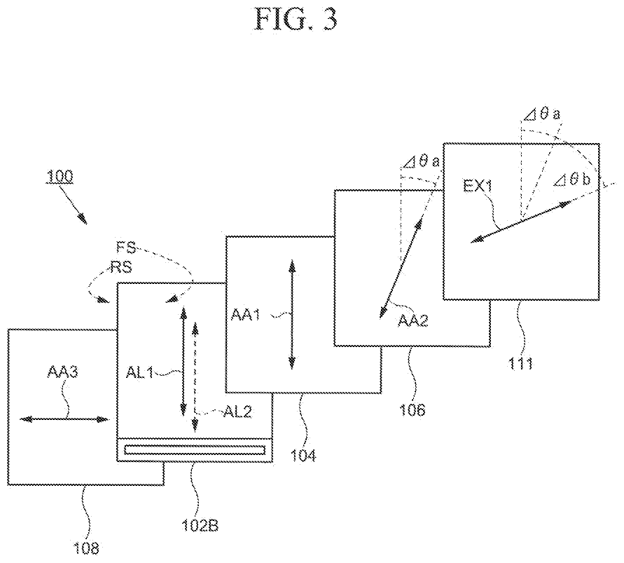

FIG. 3 shows an example of a different arrangement of retardation films with respect to the liquid crystal display device 100 shown in the second embodiment. As shown in FIG. 3, from the side of the first plane FS of a liquid crystal panel 102B, the first polarizing film 104, the second polarizing film 106, and the retardation film 111 are arranged in this order. The absorption axis AA1 of the first polarizing film 104 is arranged to align in the same direction (parallel) as the alignment axis AL1 of the liquid crystal panel 102B. The absorption axis AA2 of the second polarizing film 106 is arranged inclined by Δθa relative to the absorption axis AA1 of the first polarizing film 104. The angular difference Δθa between the two polarizing films is greater than 0 degree and 45 degrees or less, preferably 5 degrees or more and 25 degrees or less, as described above.

The stretching axis EX1 of the retardation film 111 arranged in front of the second polarizing film 106 is arranged to have an additional angle difference Δθb with respect to the absorption axis of the second polarizing film 106. It is possible for the direction of the stretching axis EX1 of the retardation film 111 to be, for example, an angle halfway between the absorption axis AA2 of the second polarizing film 106 and the angle of the absorption axis based on the specifications of the device in which the liquid crystal display device 100 is to be installed. It is possible for the direction of the stretching axis EX1 of the retardation film 111 to be, for example, an angle between the transmission axis of the second polarizing film 106 (absorption axis AA2+90 degrees) and the angle of the transmission axis (absorption axis+90 degrees) based on the specifications of the device in which the liquid crystal display device 100 is to be installed. For example, it is possible for the angle difference Δθb to be 45 degrees.

The retardation film 111 may be a ¼-wavelength retardation film. In this case, it is possible to make the emitted light circularly polarized by setting the angular difference Δθb to 45 degrees. Thereby, the intensity of transmitted light can be improved over a wide wavelength band other than the wavelength at which the light is circularly polarized. As the retardation film 111, a ½-wavelength retardation film can also be adopted.

FIG. 3 shows a case in which the liquid crystal panel 102B is an IPS (In Plane Switching) type. The liquid crystal panel 102B is a transmissive type panel, the absorption axis AA1 of the first polarizing film 104 is arranged in the same direction (parallel) as the alignment axis AL1 and alignment axis AL2 of the liquid crystal panel 102B, and the absorption axis AA1 of the first polarizing film 104 and the absorption axis AA3 of the third polarizing film 108 are arranged in a crossed Nicol (orthogonal) manner.

As shown in this embodiment, it is possible to reduce the effect of the angular difference in the absorption axis by sandwiching the retardation film 111 to conform to the absorption axis on the device side, even when the angular difference between the absorption axis of the second polarizing film 106 and the absorption axis based on the specifications of the device in which the liquid crystal display device 100 is to be incorporated is large.

### Fourth Embodiment

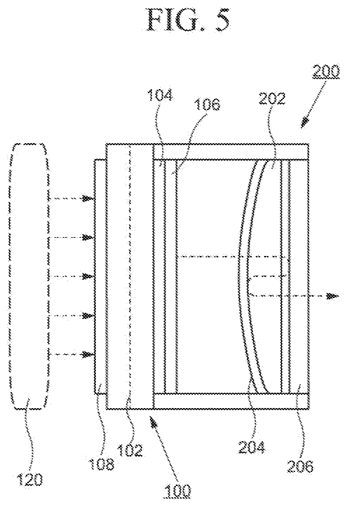

FIG. 5 shows the configuration of a head-mounted display 200 as an example of the device in which the liquid crystal display device 100 is installed. The head-mounted display 200 is configured to include the liquid crystal display device 100, a lens 202, a half-mirror 204, an optical film 206, and a light source 120.

The liquid crystal display device 100 shown in the first to third embodiments is applied to the liquid crystal display device 100. Although FIG. 5 shows an example in which the third polarizing film 108 is arranged on the light incident side of the liquid crystal panel 102, and the first polarizing film 104 and the second polarizing film 106 are arranged on the light emitted side, an additional retardation film 110 may be arranged as described in the second and third embodiments.

The optical system of the head-mounted display 200 includes the half-mirror 204 and the optical film 206 arranged so that the lens 202 is sandwiched between them. The head-mounted display 200 has an optical system configured to reflect light between the optical film 206 and the half-mirror 204 to increase the effective optical path length by combining a ¼-wavelength film and a reflective polarizing film as appropriate as the optical film 206. Light having a specified polarization axis emitted from the liquid crystal display device 100 passes through the half-mirror 204 and the lens 202, and is reflected by the optical film 206. The reflected light again enters the lens 202 and is reflected by the half-mirror 204. The reflected light by the half-mirror 204 again enters the lens 202, passes through the optical film 206, and is emitted to the viewer's side.

To optimize the optical system of the head-mounted display 200, it may be required that the absorption axis of the optical film 206 is not necessarily aligned with the side of the liquid crystal display device 100. In such cases, the liquid crystal display device 100 presented in the first to third embodiments can be used to align with the absorption axis required on the side of the head-mounted display 200, and the loss of light emitted from the light source 120 and transmitted through the liquid crystal display device 100 can be reduced. The liquid crystal display device according to an embodiment of the present invention can be flexibly adapted in head-mounted displays with various specifications.

What is claimed is:

1. A liquid crystal display device, comprising:
a transmissive liquid crystal panel having a first surface and a second surface opposite the first surface;
a first polarizing film arranged on a side of the first surface of the transmissive liquid crystal panel;
a second polarizing film arranged on an opposite side of the first polarizing film from the transmissive liquid crystal panel; and
a third polarizing film arranged on a side of the second surface of the transmissive liquid crystal,
wherein
an absorption axis of the first polarizing film is arranged parallel to an initial alignment direction of liquid crystal molecules included in the transmissive liquid crystal panel,
the first polarizing film and the third polarizing film are arranged in a crossed Nicol manner, and
an absorption axis of the second polarizing film is inclined with respect to the absorption axis of the first polarizing film.

2. The liquid crystal display device according to claim 1, wherein the absorption axis of the second polarizing film is inclined at an angle of more than 0 degrees and 45 degrees or less with respect to the absorption axis of the first polarizing film.

3. The liquid crystal display device according to claim 1, further comprising a retardation film arranged on an opposite side of the second polarizing film from the first polarizing film,
wherein a stretching axis of the retardation film is inclined at a predetermined angle with respect to the absorption axis of the second polarizing film.

4. The liquid crystal display device according to claim 3, wherein the retardation film is a ¼-wavelength retardation film.

5. The liquid crystal display device according to claim 1, further comprising a retardation film between the first polarizing film and the second polarizing film,
wherein a first direction of a stretching axis of the retardation film is between a second direction of the absorption axis of the first polarizing film and a third direction of the absorption axis of the second polarizing film.

6. The liquid crystal display device according to claim 5, wherein the retardation film is a ½-wavelength retardation film.

7. The liquid crystal display device according to claim 5, wherein the first direction is intermediate between the second direction and the third direction.

8. The liquid crystal display device according to claim 1, wherein the transmissive liquid crystal panel is an IPS liquid crystal panel or a TN liquid crystal panel.

9. A head mounted display comprising the liquid crystal display device according to claim 1.
